(19) United States
(12) Patent Application Publication
(10) Pub. No.: US 2025/0215262 A1
(43) Pub. Date: Jul. 3, 2025

(54) Recyclable 3D-Printable Preceramic Thermosets using Dynamic Crosslinking

(71) Applicant: UNM RAINFOREST INNOVATIONS, Albuquerque, NM (US)

(72) Inventor: Sungjin KIM, Albuquerque, NM (US)

(21) Appl. No.: 18/989,296

(22) Filed: Dec. 20, 2024

Related U.S. Application Data
(60) Provisional application No. 63/615,185, filed on Dec. 27, 2023.

(51) Int. Cl. C09D 183/16; B33Y 70/00; C04B 35/56; C04B 35/571; C04B 35/589; C04B 35/597

(52) U.S. Cl. CPC C09D 183/16; B33Y 70/00; C04B 35/5603; C04B 35/571; C04B 35/589; C04B 35/597; C04B 2235/483; C04B 2235/6026

(57) ABSTRACT

A three-dimensional (3D) printable material is disclosed, including a silicon-based polymer, and one or more crosslinkers, and where the one or more crosslinkers may include a dynamic crosslinker. The silicon-based polymer may include a preceramic polymer, such as a polycarbosilane. The preceramic polymer may include a polysilazane. The dynamic crosslinker may include a renewable material such as a plant-based material. The dynamic crosslinker may further include a disulfide bond, such as, for example. allyl disulfide or alternatively, an imine bond. The 3D printable material can be crosslinked with exposure of the 3D printable material to elevated temperature or radiation. The 3D printable material can be fabricated using extrusion, molding, three-dimensional printing, or a combination thereof.

### REFERENCE TO RELATED APPLICATIONS

This application claims the benefit of U.S. Provisional Patent Application No. 63/615,185, filed on Dec. 27, 2023, which is hereby incorporated by reference in its entirety.

### TECHNICAL FIELD

The present teachings relate generally to 3D printable materials and, more particularly, to recyclable 3D printable materials including dynamic crosslinking.

### BACKGROUND

Preceramic polymers are a class of silicon-based polymers that can be converted into ceramic materials through pyrolysis. Even without pyrolysis, preceramic polymers are known for their high thermal and chemical stability surpassing conventional carbon-based polymers, enabling wide-ranging applications in aerospace, energy, and biomedical fields. Importantly, most preceramic polymers can be crosslinked through thermal or photochemical activation. This amenability to crosslinking enables the preceramic polymers to be 3D printed via extrusion or stereolithographic additive manufacturing (AM) in sophisticated structures that can be converted to ceramics with shapes and functions difficult to achieve through conventional processing. Due to such advantages, preceramic polymers market size is projected to double in the coming years. However, crosslinked thermosets are non-reprocessable and non-recyclable by the nature of the permanent covalent bonds. Thus, the failed parts, wastes, or end-of-life preceramic polymer networks typically end up incinerated or landfilled. This intrinsic hurdle makes the lifecycle of preceramic materials resource- and energy-intensive, which severely counteracts the potential of the preceramic polymers as an alternative or complement to mitigate the carbon-intense polymer economy.

Therefore, it is desirable to establish procedures or avenues for the recyclability and reprocessability of preceramic polymer networks via dynamic crosslinking, that may be printable with the use of additive manufacturing (AM).

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A three-dimensional (3D) printable material. The 3D printable material includes a silicon-based polymer, and one or more crosslinkers, and where the one or more crosslinkers may include a dynamic crosslinker. Implementations of the 3D printable material include where the silicon-based polymer may include a preceramic polymer. The preceramic polymer may include a polycarbosilane. The preceramic polymer may include a polysilazane. The dynamic crosslinker may include a renewable material. The dynamic crosslinker may include a plant-based material. The dynamic crosslinker may include a disulfide bond. The dynamic crosslinker may include allyl disulfide. The dynamic crosslinker may include an imine bond. The 3D printable material is configured to be crosslinked with exposure of the 3D printable material to elevated temperature. The 3D printable material is configured to be crosslinked with exposure of the 3D printable material to externally provided radiation. The 3D printable material is configured to be extruded. The 3D printable material is configured to be molded. The 3D printable material is configured to be printed with a 3D printer. Implementations of the described techniques may include hardware, a method or process, or computer software on a computer-accessible medium.

Another 3D printable material is disclosed. The 3D printable material includes a preceramic polymer, and one or more crosslinkers, and where the one or more crosslinker may include a renewable or bio-derived dynamic crosslinker. Implementations of the 3D printable material include where the dynamic crosslinker may include a disulfide bond. The dynamic crosslinker may include allyl disulfide. The dynamic crosslinker may include an imine bond. The 3D printable material is configured to be crosslinked with exposure of the 3D printable material to elevated temperature. The 3D printable material is configured to be crosslinked with exposure of the 3D printable material to externally provided radiation. Implementations of the described techniques may include hardware, a method or process, or computer software on a computer-accessible medium.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic depiction of the present disclosure of a design of circular manufacturing of dynamic preceramic polymers, in accordance with the present disclosure.

FIG. 2 is a schematic of several proposed chemical modification strategies to add dynamic disulfide group or dynamic imine group, in accordance with the present disclosure.

FIG. 3 is a representation of several vat polymerization (VP)-printed cuboids from polycarbosilanes, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides the design and fabrication of recyclable 3D-printable preceramic thermosets using dynamic crosslinking. Dynamic crosslinks between different polymer chains can reversibly associate and/or dissociate or exchange bonds upon condition control or stimuli. Incorporating dynamic crosslinks in place of traditional covalent crosslinks can therefore allow for preceramic thermosets to be reprocessed, reshaped, and repurposed, which would significantly improve their sustainability. The study of chemical modification strategies to develop recyclable 3D-printable preceramic polymer networks using crosslinkers with dynamic bonding groups is described herein. The incorporation of dynamic crosslinkers derived from renewable resources such as plants can also be explored. This approach can therefore provide multifaceted sustainable manufacturing strategies.

The present disclosure establishes the sustainable manufacturing of 3D-printable preceramic thermosets with reprocessability that has been rarely demonstrated thus far. These approaches will therefore innovate the sustainability of the preceramic polymers and their composites in their deployments in aerospace, energy, and biomedical fields. The present teachings can provide a first-of-kind 3D-printable preceramic polymer network that can be reprocessed, reshaped, and repurposed (i) through extrusion-based additive manufacturing (AM) such as fused filament fabrication (FFF), direct ink writing (DIW), and big-area AM (BAAM), (ii) or through conventional processing such as injection molding-casting, hot-pressing, and extrusion. (iii) These materials will also be 3D-printable through photochemical AM of Vat Photopolymerization (VP) including stereolithography (SLA) or digital light processing (DLP) with higher printing resolution. (iv) Thus-printed structures will be recyclable and renewable through processing methods described in (i) and (ii). Alternatively, they can be broken down into particles and added as additives or fillers in the SLA or DLP of other preceramic polymers with dynamic bonding groups that can exchange bonding for further integration via post-treatment. (v) Finally, by incorporating bioderived crosslinkers instead of petroleum-based crosslinkers, the carbon footprint will be further reduced bolstering the carbon-efficient circular manufacturing described in expected outcomes (i-iv). These described methodologies provide improvements and advantages in recyclability, versatility, sustainability and tailorable material properties. In terms of recyclability, the use of dynamic crosslinking allows for the reprocessing, reshaping, and repurposing of the printed structures, which is an advantageous feature for preceramic polymers. The ability to use both extrusion-based additive manufacturing (AM) techniques (FFF, DIW, BAAM) and conventional processing methods (injection molding, hot-pressing) allows for flexibility in production and scalability, leading to enhanced versatility in manufacturing. The incorporation of bio-derived crosslinkers from renewable resources further enhances the sustainability of the manufacturing process and availability of sustainable source materials thereof. The present teachings addresses both recyclability and renewable sourcing, providing a comprehensive sustainable solution for preceramic polymer manufacturing. This further provides multifunctional sustainability. The ability to control crosslinker concentration and crosslinking conditions allows for optimization of chemical, mechanical, and rheological properties specific to preceramic polymers, resulting in tailorable properties. The potential to break down printed structures into particles and use them as additives or fillers in new prints offers a unique way to upcycle these specialized materials, and integrate recycled materials into new materials or products.

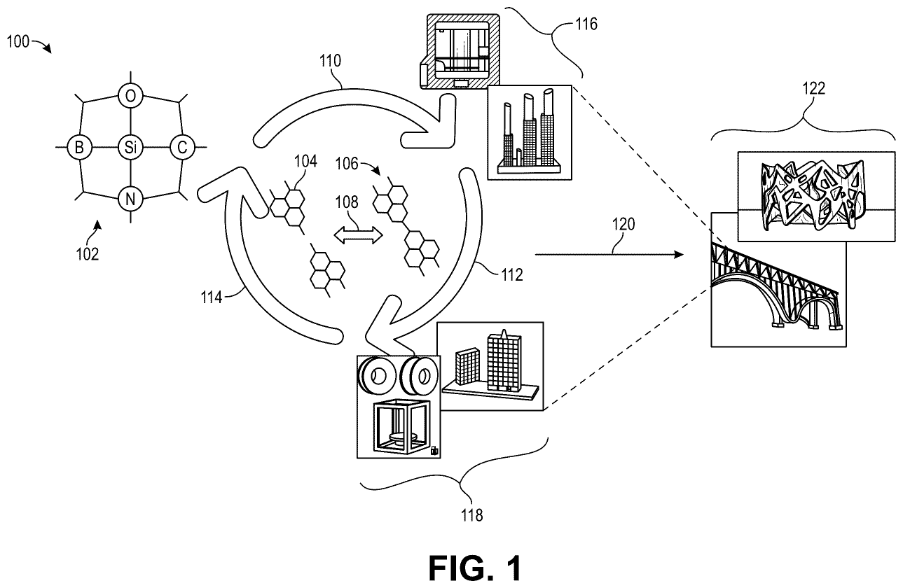

FIG. 1 is a schematic depiction of the present disclosure of a design of circular manufacturing of dynamic preceramic polymers, in accordance with the present disclosure. In a circular manufacturing process 100 as shown, a preceramic polymer 102 is used in a cyclical process of dynamic crosslinking 110, dynamic bond rearrangement 112, and dynamic bond dissociation 114. A schematic is shown of associated materials 106 undergoing a reversible bonding 108 process to become disassociated materials 104. These various materials can be fabricated into preceramic polymer thermoset materials 116, or after dynamic bond rearrangement 112, recycled preceramic polymer thermoset materials 118. Via pyrolysis 120, the polymer thermosets can be fabricated into 3D printed ceramics 122.

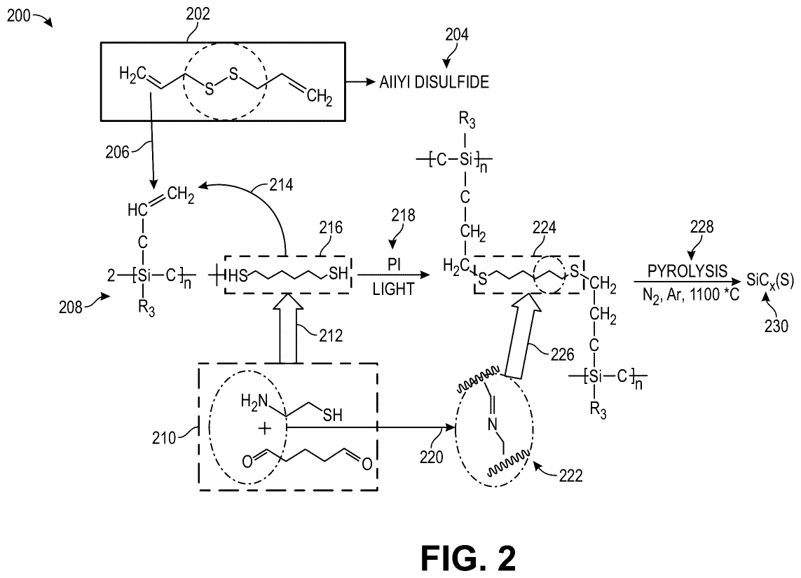

The present disclosure provides the use of the alkene cross-coupling reaction or thiol-ene click reaction to modify the preceramic polymers containing unsaturated double bonds (e.g., polycarbosilane, polysilazanes to attach dynamic groups, as shown in FIG. 2. Both the cross-coupling and thiol-ene click reactions are known for their undemanding reaction condition and high yield, thus it will provide feasible and adequate modification paths to attach the dynamic crosslinkers to the preceramic polymer chain. The crosslinker containing dynamic disulfide bonds or imine bonds will be utilized to endow the thermosets with reprocessability, as further described in regard to FIG. 2. By controlling the crosslinker concentration as well as crosslinking condition and stimuli (e.g., temperature, time, light intensity), the chemical, mechanical, and rheological properties can be optimized and enhanced accordingly for selected processing and reprocessing methods including extrusion, extrusion-based AM, stereolithography, or hot-pressing. More specifically, a bioderived crosslinker epitomized by allyl disulfide derived from garlic will be investigated for our proposed chemical modification and processing or reprocessing. Demonstration and evaluation of the circular processability by multicycle printing in desired 3D structures can be realized and the material properties can be assessed using mechanical and chemical analysis.

Preceramic polymers can include, but are not limited to, various polymeric compounds or materials, that under the appropriate environmental conditions, can be pyrolyzed and converted to ceramic compositions. Polymer derived ceramics such as these are typically silicon-based compounds, such as silicon carbide, silicon oxycarbide, silicon nitride and silicon oxynitride, and the like. In examples, illustrative polymer-derived ceramics can also include polysiloxanes (silicones), polyborosilazanes, polysilylcarbodiimides, or combination thereof. Other materials useful as preceramic materials in accordance with the present disclosure can include polycarbosilanes or polysilazanes. Polycarbosilanes are polymers that contain silicon bonded to carbon in the backbone. Exemplary polycarbosilanes can include allylhydridopolycarbosilane, poly(methylsilylene) methylene, poly(phenylsilylcarbodiimide), or combinations thereof. Polysilazanes and polycarbosilazanes are characterized by having either a —Si—N— backbone (polysilazanes) or a —R—Si—N— backbone (polycarbosilazanes) Exemplary polysilazanes or polycarbosilazanes can include perhydropolysilazane, polyureasilazane, poly(methylvinyl) silazane, Ceraset®, a commercially available polysilazane precursor.

FIG. 2 is a schematic of several proposed chemical modification strategies to add dynamic disulfide group (route indicated by arrow 212) or dynamic imine group (route indicated by arrow 226), in accordance with the present disclosure. A chemical modification scheme 200 is shown where a first path of reaction includes a dynamic disulfide group 202, in this example allyl disulfide 204, which can be derived from garlic. Via a cross coupling reaction 206 between the allyl groups in the disulfide group 202 a polycarbosilane 208 and the crosslinker containing dynamic disulfide group 202, the polymer include one or more dynamic disulfide bonds. Alternatively, the non-dynamic dithiol crosslinker 216 can be replaced by dynamic dithiol crosslinker that is formed by reacting di-aldehyde and a molecule containing amine on one end and thiol group on the other end form 220 a dynamic imine group 222. Thus-formed 210 crosslinker molecule containing dynamic imine group in the middle of the chain and thiol groups are on both ends 222 can crosslink via thiol-ene reaction 214 with polycarbosilane 208 and different polycarbosilane chains 226 with dynamic imine bonds 222 in the middle of the crosslink 224. Using photoinitiation (PI) and/or light 218, the product of the reaction 224 is formed, in some examples using the dynamic imine group 222. Next, the reaction proceeds be reacted via pyrolysis 228 under nitrogen and argon at 1100° C. to form a ceramic material 230.

Thiol-ene click reactions can include reactions between a thiol (R—SH) and an alkene (R₂C═CR₂) to form a thioether (R—S—R′). Thiol-ene reactions are useful for chemical synthesis because step growth and chain growth processes can be effectively used to form homogeneous polymer networks. In examples, photopolymerization can be employed as a radical-based reaction for applications within the nanotechnology, biomaterial, and material sciences, and used within methods described herein. In examples, the thiol-ene reaction can combine the benefits of photopolymerization reactions with click chemistry reactions. One exemplary thiol that can be used in thiol-ene click reaction can include allyl disulfide, which can be sourced as a bioavailable or bio-derived material. Bio-derived materials are products made from substances derived from living organisms, such as plants, animals, enzymes, or microorganisms. They can be either naturally occurring or synthesized, and can be an alternative to petroleum-based sources or chemicals.

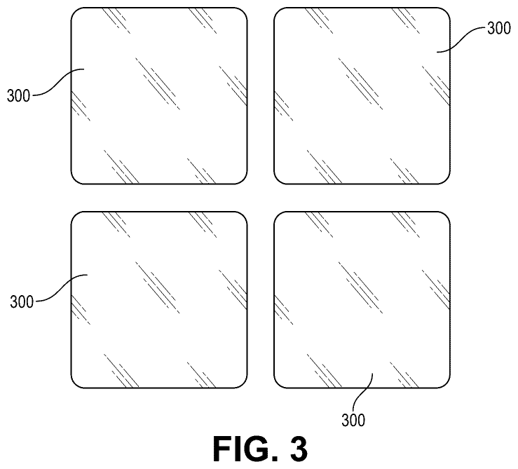

The area of thiol-ene click chemistry can be utilized in combination with other elements described herein to add dynamic imine groups to upcycle commodity plastic wastes of acrylonitrile butylene styrene (ABS) into dynamic vitrimers with better thermal-chemical-mechanical stability and FFF-printability. Chemical analysis can be employed on polysilazanes to evaluate their crosslinking behavior and in both cross-coupling and thiol-ene reactions to crosslink and 3D print polycarbosilanes using VP, as demonstrated in FIG. 3. The present disclosure provides a description of the equipment and resources necessary to support the experiments and fabrications successfully. Wet lab facilities can be used to perform chemical modifications and syntheses. The equipment for extrusion-based 3D printing and FFF can also be used as described to provide 3D printed compositions of the present disclosure. Characterization tools including tensile tester, rheometer, IR spectroscopy, and thermogravimetric analysis can be utilized, as well as the required software to generate 3D models and G-codes for AM.

FIG. 3 is a representation of several VP-printed cuboids from polycarbosilanes, in accordance with the present disclosure. The four vat-polymerization printed cuboids 300 have been formed from polycarbosilanes. A 3D printable material includes a silicon-based polymer, and one or more crosslinkers, and where the one or more crosslinker may include a dynamic crosslinker. The 3D printable material includes where the silicon-based polymer may include a preceramic polymer. The preceramic polymer may include a polycarbosilane. The preceramic polymer may include a polysilazane. The dynamic crosslinker may include a renewable material. The dynamic crosslinker may include a plant-based material. The dynamic crosslinker may include a disulfide bond. The dynamic crosslinker may include allyl disulfide. The dynamic crosslinker may include an imine bond. The 3D printable material is configured to be crosslinked with exposure of the 3D printable material to elevated temperature. The 3D printable material is configured to be crosslinked with exposure of the 3D printable material to externally provided radiation. The 3D printable material is configured to be extruded. The 3D printable material is configured to be molded. The 3D printable material is configured to be printed with a 3D printer.

Another 3D printable material is disclosed. The 3D printable material can include a preceramic polymer, and one or more crosslinkers, and where the one or more crosslinker may include a renewable or bio-derived dynamic crosslinker. The 3D printable material can include where the dynamic crosslinker may include a disulfide bond. The dynamic crosslinker may include allyl disulfide. The dynamic crosslinker may include an imine bond. The 3D printable material is configured to be crosslinked with exposure of the 3D printable material to elevated temperature. The 3D printable material is configured to be crosslinked with exposure of the 3D printable material to externally provided radiation.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A 3D printable material, comprising:
a silicon-based polymer; and
one or more crosslinkers; and wherein:
the one or more crosslinker comprises a dynamic crosslinker.

2. The 3D printable material of claim 1, wherein the silicon-based polymer comprises a preceramic polymer.

3. The 3D printable material of claim 2, wherein the preceramic polymer comprises a polycarbosilane.

4. The 3D printable material of claim 2, wherein the preceramic polymer comprises a polysilazane.

5. The 3D printable material of claim 1, wherein the dynamic crosslinker comprises a renewable material.

6. The 3D printable material of claim 1, wherein the dynamic crosslinker comprises a plant-based material.

7. The 3D printable material of claim 1, wherein the dynamic crosslinker comprises a disulfide bond.

8. The 3D printable material of claim 1, wherein the dynamic crosslinker comprises allyl disulfide.

9. The 3D printable material of claim 1, wherein the dynamic crosslinker comprises an imine bond.

10. The 3D printable material of claim 1, wherein the 3D printable material is configured to be crosslinked with exposure of the 3D printable material to elevated temperature.

11. The 3D printable material of claim 1, wherein the 3D printable material is configured to be crosslinked with exposure of the 3D printable material to externally provided radiation.

12. The 3D printable material of claim 1, wherein the 3D printable material is configured to be extruded.

13. The 3D printable material of claim 1, wherein the 3D printable material is configured to be molded.

14. The 3D printable material of claim 1, wherein the 3D printable material is configured to be printed with a 3D printer.

15. A 3D printable material, comprising:
a preceramic polymer; and
one or more crosslinkers; and wherein:
the one or more crosslinker comprises a renewable or bio-derived dynamic crosslinker.

16. The 3D printable material of claim 15, wherein the dynamic crosslinker comprises a disulfide bond.

17. The 3D printable material of claim 15, wherein the dynamic crosslinker comprises allyl disulfide.

18. The 3D printable material of claim 15, wherein the dynamic crosslinker comprises an imine bond.

19. The 3D printable material of claim 15, wherein the 3D printable material is configured to be crosslinked with exposure of the 3D printable material to elevated temperature.

20. The 3D printable material of claim 15, wherein the 3D printable material is configured to be crosslinked with exposure of the 3D printable material to externally provided radiation.
